(19) United States
(12) Patent Application Publication
(10) Pub. No.: US 2026/0170922 A1
(43) Pub. Date: Jun. 18, 2026

(54) WAGERING GAME

(71) Applicant: ESC Software LLC, Dunedin, FL (US)

(72) Inventors: Mark Vitaliano, Dunedin, FL (US); Piotr Kajpust, Schaumburg, IL (US)

(21) Appl. No.: 19/422,025

(22) Filed: Dec. 16, 2025

Related U.S. Application Data
(60) Provisional application No. 63/734,863, filed on Dec. 17, 2024.

(51) Int. Cl. G07F 17/32

(52) U.S. Cl. CPC G07F 17/3262; G07F 17/3276; G07F 17/3295

(57) ABSTRACT

A method of conducting a wagering game includes displaying an array of wagering game elements, each associated with a single first number and a single second number. Each of the first and second numbers corresponds to a potential score of a participant of an event. The method further includes receiving timestamped transient participant scores. The method increments a point total associated with each wagering game element associated with first and second numbers that match the transient participant scores. The point total is incremented by determining a number of time intervals between successive timestamps, and multiplying the number of time intervals by a number of points for each of the number of time intervals. The wagering game element having a highest point total at the end of the event is the winner, and the winning player is the player to whom the winning wagering game element is assigned.

### CROSS-REFERENCE TO RELATED APPLICATIONS

This application claims the benefit of and priority to U.S. Provisional Application No. 63/734,863, filed Dec. 17, 2024, which is hereby incorporated by reference herein in its entirety.

### TECHNICAL FIELD

The present invention relates generally to a wagering game, and in particular to a wagering game that assigns points to game elements that match the transient scores of participants in an event, and sums the assigned points over the entirety of the event.

### BACKGROUND

Wagering on sporting events has become more popular than ever. Team events such as football, basketball, hockey, or baseball, for example, allow for the choice of the winner from two participating teams. However, wagering on the progress of live events is limited, allowing for bets to be placed on the scores of the event only at predetermined breaks in the action. For example, bets can be placed on the scores of a football game after the first quarter, at half time, after the third quarter, and for the final score. Individual events, such as golf tournaments, for example, allow for the choice of winner from more than two participants, but are also limited in live wagering on the progress of the event. A need exists for a wagering game that allows players to have a continuous wager for the entirety of the event.

### SUMMARY

According to certain implementations of the present disclosure, a method of conducting a wagering game for a plurality of players includes displaying an array of a plurality of wagering game elements. The method further includes displaying (i) a first plurality of numbers adjacent to a first side of the array and (ii) a second plurality of numbers adjacent to a second side of the array. Each of the plurality of wagering game elements is associated with a single one of the first plurality of numbers and a single one of the second plurality of numbers. Each of the first plurality of numbers corresponds to a potential score of a first participant of an event and each of the second plurality of numbers corresponds to a potential score of a second participant of the event. Each of the plurality of wagering game elements is assigned to a respective player of the plurality of players of the wagering game.

According to certain implementations of the present disclosure, the method further includes receiving a first transient event score including (i) a first transient participant score for the first participant, (ii) a first transient participant score for the second participant, and (iii) a first time stamp. The first transient event score corresponds to a first one of the plurality of wagering game elements, and the first one of the plurality of wagering game elements is assigned to a first player of the plurality of players.

According to certain implementations of the present disclosure, the method further includes receiving a second transient event score including (i) a second transient participant score for the first participant, (ii) a second transient participant score for the second participant, and (iii) a second time stamp. The second transient event score corresponds to a second one of the plurality of wagering game elements, and the second one of the plurality of wagering game elements is assigned to a second player of the plurality of players. Based at least in part on at least a portion of the first transient event score and at least a portion of the second transient event score, the method further includes incrementing a point total associated with the first one of the plurality of wagering game elements.

According to certain implementations of the present disclosure, the method further includes repeating the receiving of the first transient event score, the receiving of the second transient event score, and the incrementing of the point total associated with the first one of the of the plurality of wagering game elements until the second transient event score is a final event score. The final event score includes (i) a final participant score for the first participant that is the same as the first transient participant score for the first participant, (ii) a final participant score for the second participant that is the same as the first transient participant score for the second participant, and (iii) a final time stamp. The point total is incremented by determining a number of time intervals between the first time stamp and the final time stamp, and multiplying the number of time intervals by a number of points for each of the number of time intervals to yield a points increment. The method further includes determining a winning wagering game element of the plurality of wagering game elements, the winning wagering game element having a highest point total, and determining a winning player of the plurality of players, the winning wagering game element being assigned to the winning player.

According to certain implementations of the present disclosure, each of the first plurality of numbers represents a trailing digit of the potential score of the first participant of the event, and each of the second plurality of numbers represents a trailing digit of the potential score of the second participant of the event. According to certain implementations of the present disclosure, each of the first plurality of numbers represents the potential score of the first participant of the event, and each of the second plurality of numbers represents the potential score of the second participant of the event. The event is a game of skill having scores, and each of the first participant and the second participant is a team or an individual competing in the event.

According to certain features of the above implementations of the present disclosure, the method further includes displaying an indication of the points increment awarded to the first one of the plurality of wagering game elements. According to certain features of the above implementations of the present disclosure, the method further includes displaying an indication of the point totals associated with each of the plurality of wagering game elements.

According to certain features of the above implementations of the present disclosure, the number of points for each of the number of time intervals is multiplied by an additional time bonus factor for each multiple that a total time interval represented by the number of time intervals exceeds a threshold time interval to yield the points increment. According to certain features of the above implementations of the present disclosure, the additional time bonus factor is 0.25 and the threshold time interval is 30 seconds.

According to certain features of the above implementations of the present disclosure, the method further includes displaying an animation over the first one of the plurality of wagering game elements for which the number of time intervals exceeds the threshold time interval. According to certain features of the above implementations of the present disclosure, a size of the animation increases with an excess number of time intervals by which the threshold number of time intervals is exceeded.

According to certain features of the above implementations of the present disclosure, the method further includes determining that the first transient event score includes a bonus point value, displaying an indication of the bonus point value, and adding the bonus point value to the points increment. According to certain features of the above implementations of the present disclosure, the bonus point value is 3 points.

According to certain features of the above implementations of the present disclosure, the method further includes after receiving the first transient event score, receiving a timeout event, the timeout event including a timeout start time stamp. The method further includes displaying a clock icon over the plurality of wagering game elements for a duration of the timeout event, and randomly selecting a wagering game element of the plurality of wagering game elements. The method further includes increasing the points increment to the randomly selected wagering game element by a time-out bonus factor for a time-out bonus time following the timeout start time stamp. According to certain features of the above implementations of the present disclosure, the time-out bonus time is 60 seconds and the time-out bonus factor is 10.

According to certain features of the above implementations of the present disclosure, the method further includes displaying information for a player of the plurality of players, the information including the wagering game elements assigned to the player and the point total associated with each of the wagering game elements assigned to the player, and the duration and the points increment for each of the last 10 first transient event scores.

The above summary is not intended to represent each implementation or every aspect of the present disclosure. Additional features and benefits of the present disclosure are apparent from the detailed description and figures set forth below.

### BRIEF DESCRIPTION OF THE DRAWINGS

FIG. 1 shows a two-dimensional array of a plurality of wagering game elements each associated with one of a first plurality of numbers representing the trailing digit of a potential first participant event score and also associated with one of a second plurality of numbers representing the trailing digit of a potential second participant event score, according to certain implementations of the present disclosure.

FIG. 2 shows a two-dimensional array of a plurality of wagering game elements each associated with one of a first plurality of numbers representing a potential first participant event score and also associated with one of a second plurality of numbers representing a potential second participant event score, according to certain implementations of the present disclosure.

FIG. 3 illustrates a table of transient participant event scores of four event participants associated with a four dimensional wagering game element, according to certain implementations of the present disclosure.

FIG. 4 illustrates a graphical representation of a four dimensional wagering game element transient associated with participant event scores of four event participants, according to certain implementations of the present disclosure.

FIG. 5 illustrates the steps of an exemplary method of conducting a wagering game for a plurality of players wagering on a two participant event, according to certain implementations of the present disclosure.

FIG. 6 illustrates transient event data for an event, according to certain implementations of the present disclosure.

FIG. 7 illustrates an exemplary display of the wagering game elements including an indication of the event participants, the current event score, an indication of a change in the event score, and an indication that a points increment has been awarded to one wagering game element, according to certain implementations of the present disclosure.

FIG. 8 illustrates an exemplary display of the wagering game elements including an animation over one of the wagering game elements indicative that the wagering game element is being awarded a time bonus, according to certain implementations of the present disclosure.

FIG. 9 illustrates an exemplary display of the wagering game elements including an indication that one wagering game element is being awarded bonus event points, according to certain implementations of the present disclosure.

FIG. 10 illustrates an exemplary display of the wagering game elements including indications that a timeout event has started and that a randomly selected wagering game element can receive a timeout bonus, according to certain implementations of the present disclosure.

FIG. 11 illustrates an exemplary display of information for a player including the wagering game elements assigned to the payer and the total time awarded to each of the wagering game elements during the event, according to certain implementations of the present disclosure.

While the present disclosure is susceptible to various modifications and alternative forms, specific implementations and embodiments thereof have been shown by way of example in the drawings and will herein be described in detail. It should be understood, however, that it is not intended to limit the present disclosure to the particular forms disclosed, but on the contrary, the present disclosure is to cover all modifications, equivalents, and alternatives falling within the spirit and scope of the present disclosure.

### DETAILED DESCRIPTION OF THE ILLUSTRATED IMPLEMENTATIONS

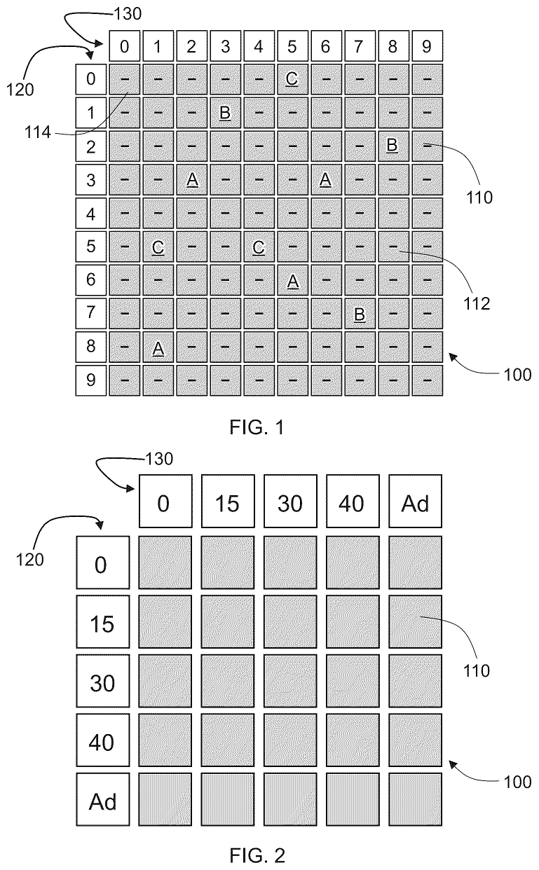

Before describing an exemplary method of conducting a wagering game for a plurality of players wagering on an event, some of the underlying concepts and constructs of the method are described. Referring generally to FIGS. 1-2, in an implementation, an exemplary method of conducting a wagering game for a plurality of players wagering on an event includes a display of an array 100 of a plurality of wagering game elements 110. The event is a game of skill having scores, for example a sporting event, and each of the participants in the event is a team or an individual competing in the event. The array 100 can be displayed, for example without limitation, on a television, on a computer monitor, or on a screen of a smartphone, a tablet, or other computing device. The array 100 has a dimensionality selected to match the number of participants in the event being wagered on. For example, for two participant events such as a football or basketball game, the array 100 will have two dimensions as shown in FIG. 1. An event having three participants would have an array having three dimensions. An event having four participants would have an array having four dimensions, and so forth.

Referring to FIGS. 1 and 2, in an implementation of the method for two participants utilizing the array 100, a first plurality of numbers 120 is displayed adjacent to a first side of the array 100 and a second plurality of numbers 130 is displayed adjacent to a second side of the array 100. Each of the plurality of wagering game elements 110 is associated with a single one of the first plurality of numbers 120 and a single one of the second plurality of numbers 130. For example, the particular wagering game element 112 in FIG. 1 is associated with the number 5 from the first plurality of numbers 120 and with the number 8 from the second plurality of numbers 130.

Each of the first plurality of numbers 120 corresponds to a potential score of a first participant of the event being wagered on, and each of the second plurality of numbers 130 corresponds to a potential score of a second participant of the event being wagered on. For example, in FIG. 1, each of the first plurality of numbers 120 represents a trailing digit of the potential score of the first participant of the event. Likewise, each of the second plurality of numbers 130 represents a trailing digit of the potential score of the second participant of the event. The use of the trailing digit of the potential scores of the participants is appropriate for most events having scoring systems of ever increasing numbers such as, for example without limitation, football or basketball.

Referring in particular to FIG. 2, there are some events for which the use a trailing digit is not sufficient to capture the possible potential scores of the participants. For example, in a tennis game of a tennis match, the points awarded within each game played progress from 0 to 15 to 30 to 40, and in some cases include Advantage (Ad in FIG. 2). Therefore, in some implementations, each of the first plurality of numbers 120 represents the actual potential score of the first participant of the event, and each of the second plurality of numbers 130 represents the actual potential score of the second participant of the event.

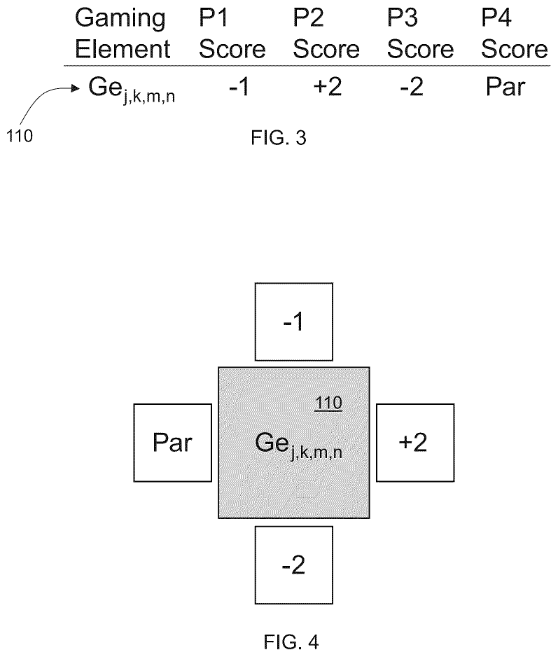

As noted above, the array 100 can be implemented to have more than two dimensions if the number of participants being wagered on is greater than two. For example, supposing the event is a golf tournament and the number of participants to be wagered on is four. Although a four dimensional array cannot be effectively graphically illustrated, FIG. 3 illustrates an exemplary way of tracking each wagering game element 110 (labeled as GE_{j,k,m,n} in FIG. 3) of a four dimensional array 100. In this nomenclature, each of the subscripts j, k, m, and n corresponds to one of the potential scores of the respective first, second, third, and fourth participants being wagered on. As shown in FIG. 3, in this implementation the potential score of each of the four participants (labeled as P1, P2, P3, and P4) is a score relative to Par. In this example, the j^{th} possible number of the plurality of numbers corresponding to potential scores of the first participant P1 is −1, the k^{th} possible number of the plurality of numbers corresponding to potential scores of the second participant P2 is +2, the m^{th} possible number of the plurality of numbers corresponding to potential scores of the third participant is −2 and the n^{th} possible number of the plurality of numbers corresponding to potential scores of the fourth participant is Par (which can be expressed as zero).

A four dimensional array of the sort shown in FIG. 3 is easily stored in memory of a computer. The four dimensional array can have as many wagering game elements 110 as needed to accommodate the desired range of scores possible in the event. Although the full four dimensional array cannot be graphically shown, FIG. 4 shows an exemplary display for the particular wagering game element 110 labeled as GE_{j,k,m,n} in FIG. 3.

In an event having two participants being wagered on, each of the plurality of wagering game elements 110 that is associated with a single one of the first plurality of numbers 120 and a single one of the second plurality of numbers 130 is assigned to a respective player of the plurality of players of the wagering game. Multiple wagering game elements 110 may be assigned to the same player for the event. For example, referring to FIG. 1, the assignment of wagering game elements 110 to three players indicated as A, B, and C are shown by the player indication within each wagering game element 110. Events having three or more participants similarly have each of the plurality of wagering game elements 110 assigned to a player. In an implementation, the assignment of the wagering game elements 110 to players is a random assignment executed by a computer or otherwise. Players of the wagering game may select the game they want to wager on, and the amount they want to wager, for example by indicating how many wagering game elements they want to purchase, and/or how much money they want to wager on each of the wagering game elements 110. After the players place their bets, the array 100 of wagering game elements is assembled, and the players are randomly assigned to their wagering game elements 110.

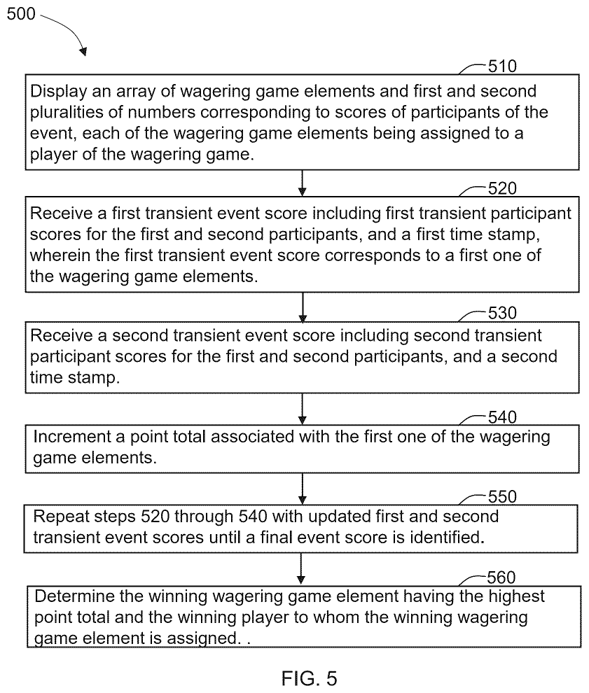

Once the number of participants is known and an appropriate array is set up, for example, the array 100, as described above and as shown in FIGS. 1-4, conducting the method for wagering on the event may proceed. Turning now to FIG. 5, the steps of an exemplary method 500 of conducting a wagering game for a plurality of players wagering on a two participant event are illustrated. The method 500 is essentially the same for events having three or more participants except as noted below. At step 510, the array 100 is displayed with the first plurality of numbers 120 and the second plurality of numbers 130, and each of the wagering game elements 110 assigned to a player of the wagering game.

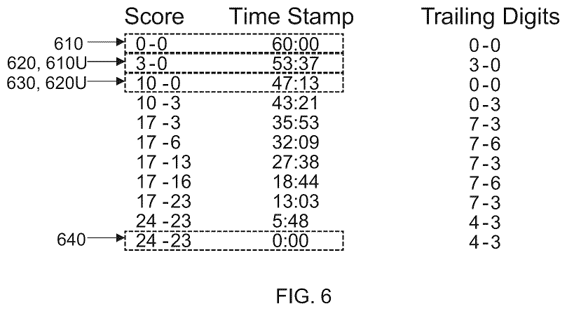

At step 520, a first transient event score is received. Referring briefly to FIG. 6 for reference, the first transient event score 610 is indicated to be 0-0. In the left-most column labeled Score, the first transient event score 610 includes a first transient participant score for the first participant (shown as zero) and a first transient participant score for the second participant (shown as zero). The first transient event score 610 also includes a time stamp shown as 60:00. This exemplary time stamp is reflective of the total time remaining at the start of an event, which in this example is an hour long. In other implementations the time stamp can be adjusted as appropriate for events having other lengths of time or can be started at zero and counted up as time elapses in the event. The right-most column in FIG. 6 shows the trailing digits of the first transient event score 610. Events having more than two participants would have as many transient participant scores as there are participants.

At step 530, a second transient event score 620 is received. Referring again briefly to FIG. 6 for reference, the second transient event score 620 is indicated to be 3-0. The second transient participant score for the first participant is 3 and the second transient participant score for the second participant is zero. The second transient event score 620 also includes a time stamp of 53:37. The right-most column in FIG. 6 shows the trailing digits of the second transient event score 620.

Referring to FIG. 1, the one wagering game element 114 of the plurality of wagering game elements 110 that corresponds to the trailing digits of the first transient event score 610 is identified. For example, the one wagering game element 114 is the wagering game element 110 that corresponds to the trailing digits 0-0 of the first transient event score 610 as shown in FIG. 1. At step 540, a point total associated with the one wagering game element 114 is positively incremented based on the participant scores of the first transient event score 610. The number of points awarded to the one wagering game element 114 in the positive increment is based on the difference in the time stamps of the first transient event score 610 and the second transient event score 620.

In an implementation, the point total associated with the one wagering game element 114 is incremented by an amount that is determined in two steps. The first step is determining a number of time intervals there are between the time stamps of the first transient event score 610 and the second transient event score 620. In other words, the first step is determining how long the first transient event score 610 remains the score of the event. The second step is multiplying the number of time intervals by a number of points awarded for each of the number of time intervals to yield the positive increment.

In this determination, the actual time span of each time interval can be pre-selected, for example without limitation, to be one or more minutes, one or more seconds, or one or more fractions of a second. In some implementations, the time interval can be varied depending on how much time remains in the event. For example, some sporting events add a tenth of a second counter to the time remaining in the event when the time remaining is under a minute. Therefore, the points awarded for matching the transient score in the last minute of the event (or for the entire event) could be based on time intervals of tenths of a second. The time interval is flexible, can vary within an event, and can be any length of time that is appropriate for matching the time stamps of the transient event scores.

In other implementations, the event may not have a predetermined length of time, for example, a baseball game. The transient event scores 610, 620 of a baseball game could include an external time stamp indicative of the actual time of day or the time elapsed since the beginning of the event, in which case, step 540 would not change from the description above. The same sort of an external time stamp could be used in a golf tournament or in a tennis match where the tournament or the match itself has no inherent measurement of time. Data for the events as described herein is readily available and can be parsed as described herein using an application programming interface (API) that can retrieve data and parse the data for the scores and time stamps, both inherent time stamps of the event and external time stamps for events lacking an inherent time stamp.

The number of points awarded for each of the number of time intervals can be adjusted as desired for a particular type of event, to achieve a desired range of final scores for the players, or depending on how many features (as described below) are included in the wagering game. For example, in an implementation a single point is awarded for each time interval (subject to any bonuses as described below). In other implementations, multiple points are awarded for each time interval. In one implementation, single or multiple points are awarded for each time interval, but at the end of the event, all of the awarded points are normalized to a predetermined scale or as a fraction of a hole when the winning player is being determined. In an implementation, the payout awarded to the winning player is computed based at least in part on the features included in the game.

Upon completion of step 540 of the method 500, a first transient event score 610 and its associated time stamp and a second transient event score 620 and its associated time stamp have been received and a points increment has been added to the one wagering game element 114 associated with first and second numbers that correspond to the first transient event score 610. The points increment has been computed based on the time between the time stamps of the first and second transient event scores 610, 620.

At step 550, the receiving of the first transient event score 610 and the second transient event score 620 effectively repeats. The next row of the transient event data as gathered by the API and shown in FIG. 6 is parsed for score and time stamp. Effectively for the purposes of description, association, and computation as described above, the second transient event score 620 is repurposed as the updated first transient event score 610U, and a third transient event score 630 is parsed and becomes the updated second transient event score 620U. Steps 520 through 540 as described above are repeated on the updated first and second transient event scores 610U and 620U as they were executed on the original first and second transient event scores 610 and 620. Steps 520 through 540 are repeated until the third transient event score 630 is the final event score 640.

This occurs when the third transient event score 630 is the same as the second transient event score 620 or when the third transient event score 630 has a time stamp indicative of the end of the event. If the participant scores of the final event score 640 are not the same, i.e., if there is a winner, then it is confirmed that the event has ended. However, if the participant scores of the final event score 640 are the same, the method 500 checks to see if the particular event allows for ties. If not, the API will continue to receive transient event scores for an overtime period of the event until the overtime period has ended with another potential final event score 640. In an implementation, the data for an event includes a final event score 640, or another field in the data includes an indication of whether the event is still active or is non-active. Thus, either through the timestamp being indicative of the end of the event, or through an indication that the event is non-active, or through both, or through other indications in the data, the end of the event and the final event score 640 is identified.

When the final event score 640 has been identified, the number of time intervals is determined for the time between the time stamp of the final event score 640 (which is effectively the updated second transient event score 620U) and the updated first event score 610U. The number of time intervals is multiplied by the number of points awarded for each time interval to yield the final points increment awarded to the one wagering game element 114 associated with first and second numbers that correspond to the updated first transient event score 610U.

After the awarding of the final points increment as described above, the method 500 at step 560 determines the winning wagering game element to be the wagering game element 110 of the plurality of wagering game elements 110 having the highest point total. Also at step 560 the winning player is determined to be the player to whom the winning wagering game element is assigned. In an implementation, an indication of the point totals associated with each of the plurality of wagering game elements 110 is displayed. In an implementation, after completion of the game, money is deposited for the winning amount in an account of the winning player, the winning amount based at least in part on the amount the player initially bet on each wagering game element. As discussed further below, the winning amount can vary based on additional features included in the method 500.

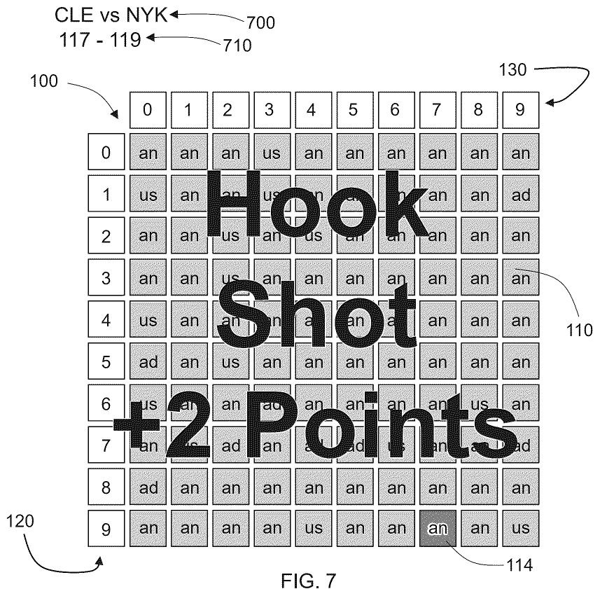

Referring to FIG. 7, in an implementation, the array 100 of the plurality of wagering game elements 110 further includes an indication of the participants in the event 700 and of the current event score 710. In the example of FIG. 7, the event is a basketball game between the Cleveland Cavaliers (CLE) and the New York Knicks (NYK). An indication of a change in the event score as received in the updated first transient event score 610U is displayed over or in association with the array 100. For example, a text message is overlaid on top of the array 100 in FIG. 7 that reads “Hook Shot +2 Points.” Other indications in the change of the event score can also be overlaid on top of the array 100, including, for example for a basketball game, “Layup +2 Points,” “Dunk +2 Points,” “Jump Shot +2 Points,” “Hook Shot +2 Points,” “Jump Shot +3 Points,” and “Free Throw Made +1 Point.” Other events can have similar indications displayed appropriate to the event, for example for a football game, “Touchdown +6 points,” In an implementation, an indication that a points increment has been awarded to the one wagering game element 114 is also displayed. In the example of FIG. 7, the awarded wagering game element 114 is shaded a different color.

Features in addition to those described above can be added to the method 500. Some implementations include a time bonus that is added to the points increment awarded to the one wagering game element 114 if the event score remains the same for a time that exceeds a threshold time. For example, if the first transient event score 610 (or the updated first transient event score 610U)(hereinafter referred to as “the score (610 or 610U)”) remains the same for longer than a threshold time interval, then the number of points awarded for each of the number of time intervals that the score (610 or 610U) remains the same is multiplied by an additional time bonus factor for each multiple that a total time interval represented by the number of time intervals exceeds the threshold time interval to yield the points increment. The threshold time interval here can be an inherent interval for events having an inherent duration. However, events for example, golf or tennis matches, that rely on an external accounting for time could define the threshold time interval here as determined by the external time.

For example, for a threshold time interval of 30 seconds, if the score (610 or 610U) remains the same for any number of time intervals having a total time of less than 30 seconds, then there is no additional time bonus. However, if the score (610 or 610U) remains the same for a number of time intervals having a total time of between 30 and 60 seconds (a 1X multiple) then the additional time bonus factor is 1.25X. If the score (610 or 610U) remains the same for a number of time intervals having a total time of between 60 and 90 seconds (a 2X multiple) then the additional time bonus factor is 1.50X. If the score (610 or 610U) remains the same for a number of time intervals having a total time of between 90 and 120 seconds (a 3X multiple) then the additional time bonus factor is 1.75X, and so forth. Written in a closed form, this is the same as saying that if the first transient event score 610 (or the updated first transient event score 610U) remains the same for longer than a threshold time interval, for example 30 seconds, then the number of points awarded for each of the number of time intervals that the score (610 or 610U) remains the same is multiplied by an additional time bonus factor, for example 0.25, for each multiple that a total time interval represented by the number of time intervals exceeds the threshold time interval to yield the points increment.

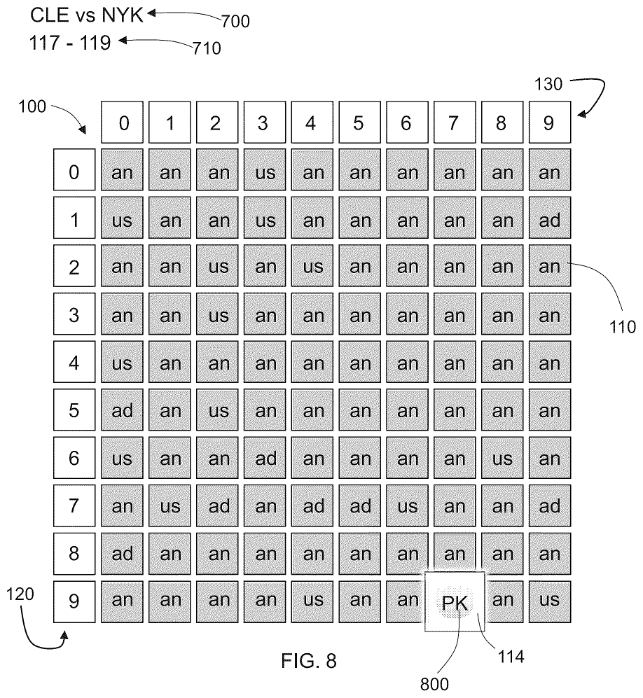

In an implementation, the bonus time feature is accompanied by an added display element. For example, referring to FIG. 8, the method 500 further displays an animation 800 over the one of the plurality of wagering game elements 114 for which the number of time intervals exceeds the threshold time interval. In an implementation the animation 800 is a flame, and the flame grows in size in step with an excess number of time intervals by which the threshold number of time intervals is exceeded.

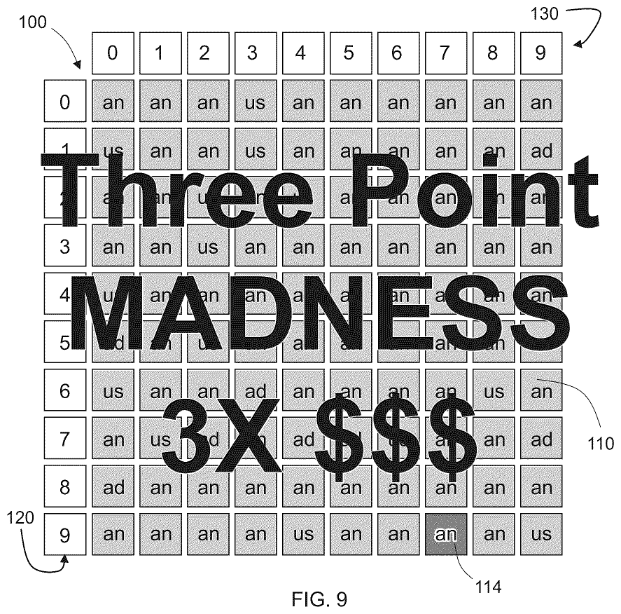

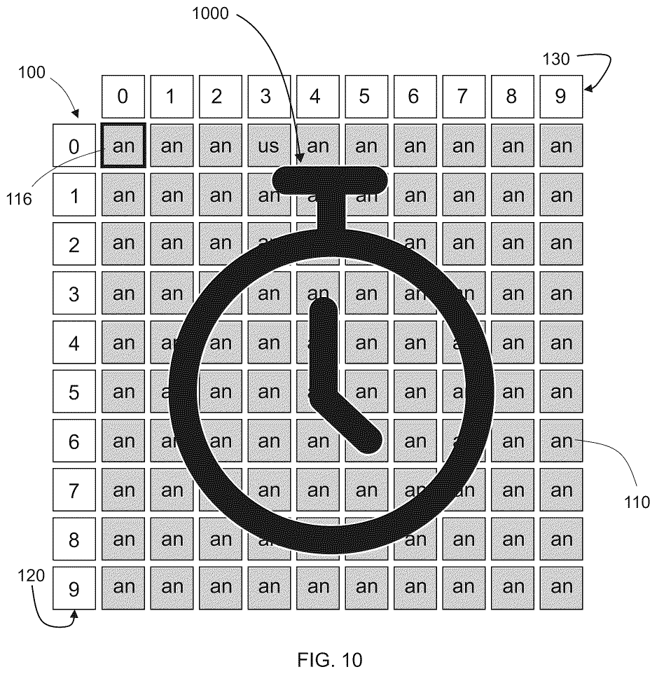

In an implementation, bonus event points are added to the points increment awarded to the one wagering game element 114. For example, bonus event points can be awarded if a participant scores in a particular way or a way that is outside of ordinary scoring. An example of this is if a participant hits a three-point shot in a basketball game. In such a circumstance, in addition to the points increment otherwise computed for the one wagering game element 114, a bonus point value, for example the amount of points equal to three additional time intervals, is added to the points increment. In another implementation, three points are added to the points increment. The method 500 would first determine that the score (610 or 610U) includes a bonus point value. The method 500 would then add the bonus point value to the points increment as noted above. In an implementation as shown in FIG. 9, the method 500 would further display an indication of the bonus point value in connection with the one wagering game element 114 and/or the array 100.

In an implementation, the method 500 includes a timeout feature. After the event has begun, for example after receiving the first transient event score 610, the API may parse a timeout event in the event data shown in FIG. 6. The timeout event includes a timeout start time stamp. Referring to FIG. 10, upon receiving the timeout event, the method 500 displays an indication, for example a clock 1000, overlaid on the array 100 for the duration of the timeout event. Further, the method 500 randomly selects one of the wagering game elements 110 and increases the points increment provided to the randomly selected one wagering game element 116 by a timeout bonus factor for a timeout bonus time following the timeout start time stamp. Therefore, after the timeout is over and the event has resumed, if the randomly selected one wagering game element 116 is the one wagering game element 114 that corresponds to the score (610 or 610U) within the timeout bonus time after the timeout start time stamp, the points increment awarded to the one wagering game element 114 is increased by a timeout bonus factor. In an implementation the timeout bonus time is 60 seconds and the timeout bonus factor is 10X. in other implementations other timeout bonus times and timeout bonus factors may be applied. The timeout bonus time here can be an inherent interval for events having an inherent duration. However, events for example, golf or tennis matches, that rely on an external accounting for time could define the timeout bonus time here as determined by the external time.

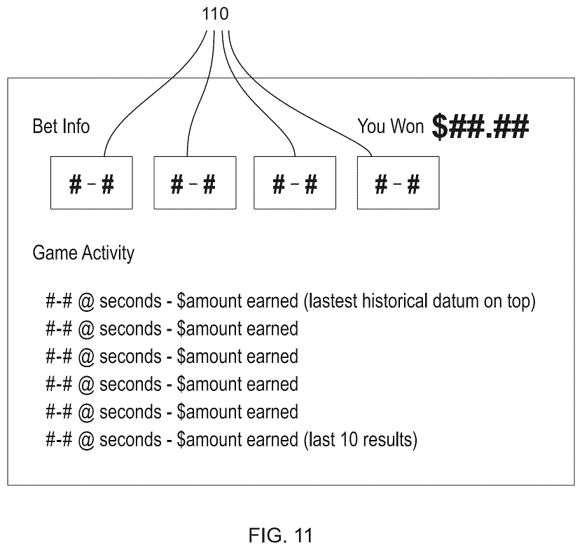

In an implementation, referring to FIG. 11, the method 500 further displays information for a player. Displayed information includes the wagering game elements 110 assigned to the player. The point total (or total time) awarded to each of the wagering game elements 110 assigned to the player is displayed. In an implementation, the amount of money won for each is the wagering game elements 110 is also displayed. In an implementation the method 500 also displays the duration and the points increment for each of the last ten scores (610 or 610U). A complete log of the event that includes all of the scores (610 or 610U) is downloadable by the player.

One or more elements or aspects or steps, or any portion(s) thereof, from one or more of any of the above implementations and/or the below claims can be combined with one or more elements or aspects or steps, or any portion(s) thereof, from one or more of any of the other above implementations and/or below claims or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

1. A method of conducting a wagering game for a plurality of players, the method comprising:
displaying an array of a plurality of wagering game elements;
displaying (i) a first plurality of numbers adjacent to a first side of the array and (ii) a second plurality of numbers adjacent to a second side of the array such that each of the plurality of wagering game elements is associated with a single one of the first plurality of numbers and a single one of the second plurality of numbers, each of the first plurality of numbers corresponding to a potential score of a first participant of an event and each of the second plurality of numbers corresponding to a potential score of a second participant of the event, each of the plurality of wagering game elements being assigned to a respective player of the plurality of players of the wagering game;
receiving a first transient event score including (i) a first transient participant score for the first participant, (ii) a first transient participant score for the second participant, and (iii) a first time stamp, the first transient event score corresponding to a first one of the plurality of wagering game elements, the first one of the plurality of wagering game elements being assigned to a first player of the plurality of players;
receiving a second transient event score including (i) a second transient participant score for the first participant, (ii) a second transient participant score for the second participant, and (iii) a second time stamp, the second transient event score corresponding to a second one of the plurality of wagering game elements, the second one of the plurality of wagering game elements being assigned to a second player of the plurality of players; and
based at least in part on at least a portion of the first transient event score and at least a portion of the second transient event score, incrementing a point total associated with the first one of the plurality of wagering game elements.

2. The method of claim 1, wherein the point total is incremented by:
determining a number of time intervals between the first time stamp and the second time stamp; and
multiplying the number of time intervals by a number of points for each of the number of time intervals to yield a points increment.

3. The method of claim 2, further comprising:
displaying an indication of the points increment awarded to the first one of the plurality of wagering game elements.

4. The method of claim 1, wherein the event is a game of skill having scores, and each of the first participant and the second participant is a team or an individual competing in the event.

5. The method of claim 1, wherein each of the first plurality of numbers represents a trailing digit of the potential score of the first participant of the event, and each of the second plurality of numbers represents a trailing digit of the potential score of the second participant of the event.

6. The method of claim 1, wherein each of the first plurality of numbers represents the potential score of the first participant of the event, and each of the second plurality of numbers represents the potential score of the second participant of the event.

7. The method of claim 1, further comprising:
repeating the receiving of the first transient event score, the receiving of the second transient event score, and the incrementing of the point total associated with the first one of the of the plurality of wagering game elements until the second transient event score is a final event score, the final event score including (i) a final participant score for the first participant that is the same as the first transient participant score for the first participant, (ii) a final participant score for the second participant that is the same as the first transient participant score for the second participant, and (iii) a final time stamp, wherein the point total is incremented by:
determining a number of time intervals between the first time stamp and the final time stamp; and
multiplying the number of time intervals by a number of points for each of the number of time intervals to yield a points increment.

8. The method of claim 7, further comprising:
determining a winning wagering game element of the plurality of wagering game elements, the winning wagering game element having a highest point total; and
determining a winning player of the plurality of players, the winning wagering game element being assigned to the winning player.

9. The method of claim 2, further comprising:
displaying an indication of the point totals associated with each of the plurality of wagering game elements.

10. The method of claim 2, wherein the number of points for each of the number of time intervals is multiplied by an additional time bonus factor for each multiple that a total time interval represented by the number of time intervals exceeds a threshold time interval to yield the points increment.

11. The method of claim 10, wherein the additional time bonus factor is 0.25 and the threshold time interval is 30 seconds.

12. The method of claim 10, further displaying an animation over the first one of the plurality of wagering game elements for which the number of time intervals exceeds the threshold time interval.

13. The method of claim 12, wherein a size of the animation increases with an excess number of time intervals by which a threshold number of time intervals is exceeded.

14. The method of claim 2, further comprising:
determining that the first transient event score includes a bonus point value;
displaying an indication of the bonus point value; and
adding the bonus point value to the points increment.

15. (canceled)

16. The method of claim 2, further comprising:
after receiving the first transient event score, receiving a timeout event, the timeout event including a timeout start time stamp;
displaying a clock icon over the plurality of wagering game elements for a duration of the timeout event;
randomly selecting a wagering game element of the plurality of wagering game elements; and
increasing the points increment to the randomly selected wagering game element by a time-out bonus factor for a time-out bonus time following the timeout start time stamp

17-18. (canceled)

19. The method of claim 13, further comprising:
determining that the first transient event score includes a bonus point value;
displaying an indication of the bonus point value; and
adding the bonus point value to the points increment.

20. (canceled)

21. The method of claim 20, further comprising:
after receiving the first transient event score, receiving a timeout event, the timeout event including a timeout start time stamp;
displaying a clock icon over the plurality of wagering game elements for a duration of the timeout event;
randomly selecting a wagering game element of the plurality of wagering game elements; and
increasing the points increment to the randomly selected wagering game element by a time-out bonus factor for a time-out bonus time following the timeout start time stamp.

22. The method of claim 21, wherein the time-out bonus time is 60 seconds and wherein the time-out bonus factor is 10.

23. (canceled)

24. The method of claim 2, further displaying information for a player of the plurality of players, the information including the wagering game elements assigned to the player and the point total associated with each of the wagering game elements assigned to the player.

25. The method of claim 24, further displaying for each of the wagering game elements assigned to the player, the duration and the points increment for each of the last ten first transient event scores.
